(19) United States
(12) Patent Application Publication
(10) Pub. No.: US 2017/0320082 A9
(43) Pub. Date: Nov. 9, 2017

(54) REUSABLE SPRAY BOTTLE

(71) Applicants: ALBERT R. KELLY, Douglaston, NY (US); George H. Schmidt, Douglaston, NY (US)

(72) Inventors: ALBERT R. KELLY, Douglaston, NY (US); George H. Schmidt, Douglaston, NY (US)

(21) Appl. No.: 14/546,985

(22) Filed: Nov. 18, 2014

Related U.S. Application Data
(63) Continuation-in-part of application No. 14/138,276, filed on Dec. 23, 2013, now abandoned.
Application No. 14/138,276 is a continuation of application No. 13/342,127, filed on Jan. 2, 2012, now abandoned.
Application No. 13/342,127 is a continuation-in-part of application No. 29/374,376, filed on Aug. 8, 2011, now Pat. No. D671004.

(51) Int. Cl. B05B 11/00

(52) U.S. Cl. CPC B05B 11/0097; B05B 11/3042; B05B 11/0008; B05B 11/0037

(57) ABSTRACT

Rechargeable containers and dispensers, in particular spray bottle dispensers including structures such as strips, pouches, pills, capsules and the like for providing concentrates of chemical agents for charging or recharging the spray bottle dispenser, preferably, individual chemical refill charges containing chemical concentrate are deployed within the spray bottle dispenser to fully contain any inadvertent spillage of chemicals, and to insure a high degree of safety against accidental spills or ingestion. The device is specifically designed for reuse, having a wider opening which is easier to fill, clean and refill without spills, readily accommodates concentrate inserts in any format, minimizes trigger failure, and has a wide base for stability.

### CROSS-REFERENCE TO RELATED APPLICATIONS

This application is a continuation-in-part of co-pending patent application Ser. No. 14/138,276, filed Dec. 23, 2013, which in turn is a continuation of patent application Ser. No. 13/342,172, filed Jan. 2, 2012, now abandoned, which in turn was a continuation in part of application Ser. No. 29/374,376, filed on Aug. 8, 2011, now Patent No. D671,004, the entirety of all of which are incorporated herein by reference thereto.

### FIELD OF THE INVENTION

This invention relates to rechargeable dispensers, in particular, rechargeable spray bottle dispensers, that can be recharged or refilled. Specifically, the present invention is particularly directed to spray bottle dispensers having chemicals associated with them to be dispensed that can be recharged by simply adding water or some other suitable solvent to the spray bottle to form a diluted chemical reagent.

### BACKGROUND OF THE INVENTION

It will be recognized that in today's environment of numerous regulations to control pollution, and consumer and industrial awareness for conserving resources and reducing landfill waste, it is highly desirable to promote the reuse of products that maintain their utility, and dispose of only products that no longer have any utility. Many manufactures are currently selling ready-to-use refills in larger containers to allow consumers to refill spray bottles with their commercial solution. One major brand is doing an on-line market test of a mini-pouch filled with a concentrate that is poured into an empty spray bottle, which is then filled with water. Three refill pouches are offered at the equivalent price of three ready-to-use spray bottles of that same brand.

However, most consumers are reluctant to adopt such methods apparently due to the inconvenience of having to create a use-dilution, in the absence of an attractive cost savings incentive for the added steps involved with the recharging process of the spray bottles. In particular, there is the inconvenience in removing the spray head to open the container, pouring the refill or the chemical concentrate into the empty spray bottle without spilling, refilling the bottle with water, and re-attaching the spray head to the spray bottle. In addition, recharging can be a messy undertaking due to spillage of refills or chemical concentrate while pouring from one container to the other, or accidentally knocking over the bottle being filled due to its instability when empty.

Some spray bottle manufacturers have marketed concentrates in multi-chambered cartridges that fit into standard spray bottle openings, which in turn are punctured by the trigger dip tube to release a measured amount of the concentrate into the spray bottle that has been pre-filled with the proper amount of water. These cartridges are costly, and can be broken inadvertently at the risk of spilling or even being swallowed by a small child. Some even supply concentrates in “pods” which are attached to the bottom of a specially designed spray bottle, which when inverted will release a measured amount of concentrate into a chamber, when turned upright into the body of the spray bottle filled with water.

### SUMMARY OF THE INVENTION

The earlier development by the inventors herein of a unique three piece wide-mouthed spray bottle as is described in co-pending patent application Ser. No. 29/374,376, which issued to Patent No. D671,004 on Nov. 20, 2012, was key to making the present invention possible. The earlier invention comprises a three-piece unit comprising (1) a bottle with an opening of 1.5 to 3 inches, incorporating screw-threads for attachment of (2) an adaptor-cap which incorporates female screw-threads for attachment to the bottle, and screw-threads for attaching (3) a pump-sprayer device with a trigger handle. Heretofore, all standard spray bottles are configured as two-piece units comprising a bottle containing the liquid formulation to be dispensed, with screw-threads for attaching a pump-spray device/trigger onto an opening of one-inch in diameter. The bottles, while preferably round in shape, may be square, rectangular, multi-angled, oval or the like. This pump sprayer is the functional component and comprises moving parts which are designed and selected for the intended useful life of the product.

For consumer products, the pump-spray mechanism is generally limited to its use on a single spray bottle. For institutional products, which are designed for re-use, the pump-spray mechanism is engineered to be more durable and is made suitable for repeated use. For use in the instant invention it is essential that the pump-spray device be engineered for reuse, preferably with plastic components, as metal parts like springs are the items that are prone to fail first.

Pumps that exploit the use of plastic to replace metal springs are supplied by ARMINAK, a fabricator located in Azusa, CA. What makes the three piece unit of the invention unique is the adaptor-cap, which serves two purposes. The first is to allow for the use of standard pump-spray device or triggers, which are widely manufactured for one-inch diameter openings, and are intended for use with this invention. In this way, if the pump spray device or trigger does fail, the entire wide-mouthed bottle does not need to be replaced. The second important purpose is the ability of the adaptor-cap to accommodate screw-threads for properly attaching and sealing this adaptor-cap to the wide-mouthed opening of between 1.5 and 3 inches in diameter, and preferably at least two inches in diameter. This significantly larger opening makes it much easier to fill the spray bottle with water, and also much easier to clean and to then re-fill with water, than is the case with the standard 1-inch diameter opening. This wide-mouthed bottle is also ideally suited for accepting concentrate-inserts in any format for creating and activating a wide variety of spray bottle solutions, including hard surface cleaners, sanitizers, and disinfectants; plant cleaners and nutrients; pet care products; carpet and fabric care products; odor control products; and virtually any product that can be delivered in a spray bottle format. Significantly, such concentrates can be provided in virtually any form, including liquid concentrates in water-soluble pouches or in measured amounts; as treatments, for example, on fabric composites which can't be broken, swallowed or spilled, or even as powders, capsules or tablets. The re-usability of this wide-mouthed spray bottle is not dependent on the delivery of concentrates in any specific format. Where the re-use of the wide-mouthed spray bottle will be dedicated to the use of a single product formulation, the bottle can be permanently labeled by any method that will survive reuse. If the bottle is to be re-used for different formulations, then its unique conical shape can accommodate use of hood-shaped plastic labels that would be held in place by the closure of the pump-spray device, and not interfere with the application or removal of the applicator-cap.

Possible manufacturing materials for the wide-mouth spray bottle include polycarbonate, the same material as some soda and water bottles are made from, as these materials are extremely durable and water clear. There has been some concern about using this material to package consumable food products, as it contains bisphenol-A (BPA), a substance suspected of impacting hormonal chemistry in the body. However, it is not a significant concern in applications involving cleaning materials. There is a substitute material being used, TRITAN™ resin which has the same properties as polycarbonate but without the BPA. It is more costly than polycarbonate but is advantageous in applications where BPA must be avoided or minimized. The cap can also be injection molded in either polycarbonate or TRITAN™ if clarity is needed. If not, polypropylene could be used either in a natural or semi-transparent effect, or in bright colors. This is a reasonably inexpensive material that is strong and break resistant. Various styrenes can also be considered but these are not necessarily as impervious to breakage.

Among the key benefits of the spray bottle of the invention, the following may be noted: (1) designed for reuse—wider opening (wide mouth or “Smart Mouth™”) is easier to fill with water without spilling, easier to clean, and easier to refill; (2) readily accommodates concentrate inserts in any format—liquid solutions in measured amounts, water-less liquids or powders in water-soluble pouches, liquids or powders embedded in nonwoven fabric sleeves, or soluble tablets or capsules; (3) trigger failure will be minimized by use of all plastic components, as opposed to metallic springs, and will not require total spray bottle replacement, as was the case with other known wide mouthed bottles. Structural benefits include: (1) plastic spray bottle can be clear, translucent, or opaque; (2) shape is conducive to maintaining uniform wall thickness in blow molding; (3) shape not critical, can be square, rectangular, multi-angled, oval or the like; (4) wider base makes it more stable; and (5) easy-on, easy-off screw top is more convenient to use.

The subject improved system may be made and used in accordance with the apparatus and methods described in detail below. The invention also lends itself for use with particulate products not readily soluble in water or other diluents. In this case, the particulate products may have particles reduced in size to nanoparticle sizes and in this form incorporated into the delivery mechanism as, for example, a non-woven strip, plastic pouch or the like. Clogging of the trigger mechanism by non-soluble particles is thereby avoided. Other additives and agents to be supplied for recharging of the bottle will not settle out or interfere with delivery of the product through the spray nozzle.

Other objects, features and advantages of the present invention will be apparent when the detailed descriptions of the preferred embodiments of the invention are considered with reference to the accompanying drawings, which should be construed in an illustrative and not limiting sense as follows.

### BRIEF DESCRIPTION OF THE DRAWINGS

For the purposes of illustrating the various aspects of the invention, wherein like numerals indicate like elements, there are shown in the drawings simplified forms of the device of the invention that may be employed, it being understood, however, that the invention is not limited by or to the precise arrangements shown. The drawings may not be to scale, and the aspects of the drawings may not be to scale relative to each other. To assist those of ordinary skill in the relevant art in making and using the subject matter hereof, reference is made to the appended drawings and figures, wherein:

FIG. 1 is a front, side and rear elevation view of the new spray container;

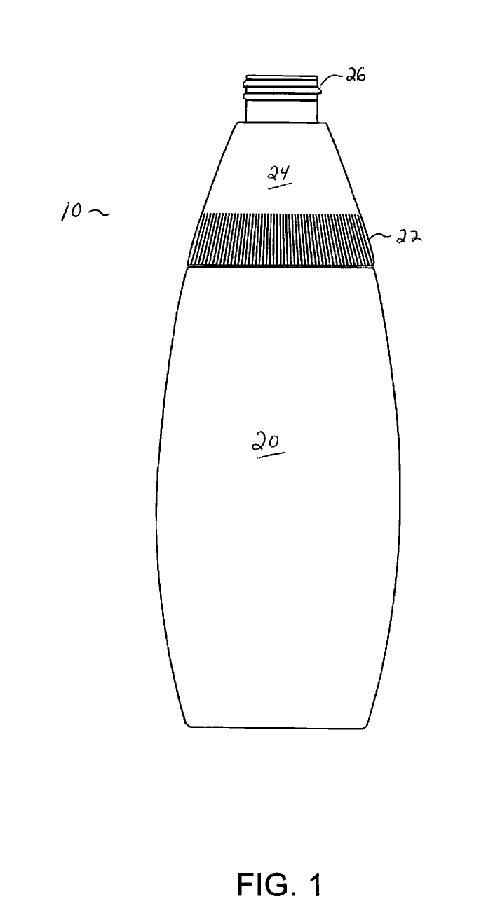

FIG. 2 is a top perspective view thereof;

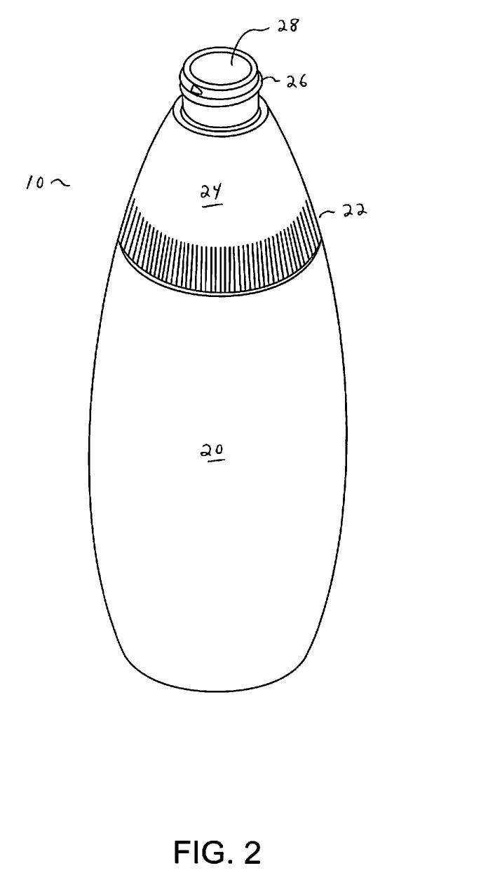

FIG. 3 is a bottom perspective view thereof;

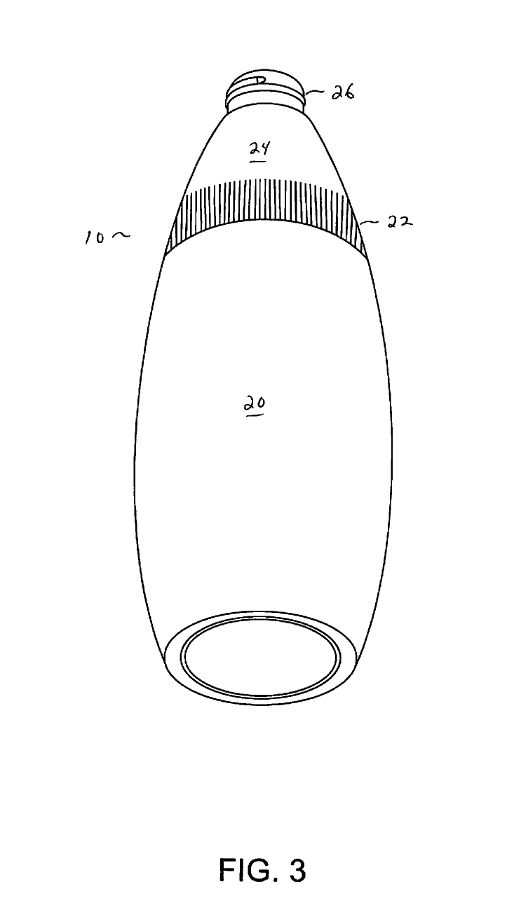

FIG. 4 is a top view thereof;

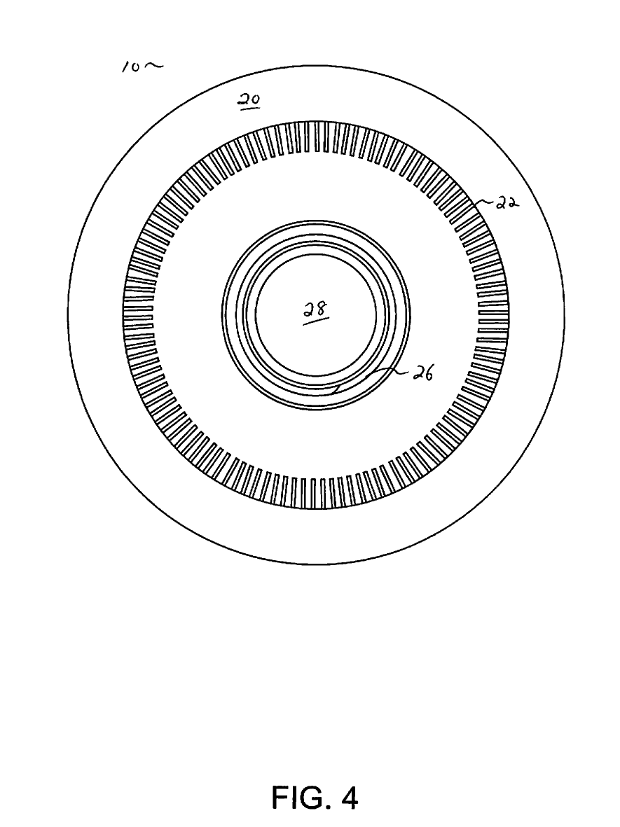

FIG. 5 is a bottom view thereof;

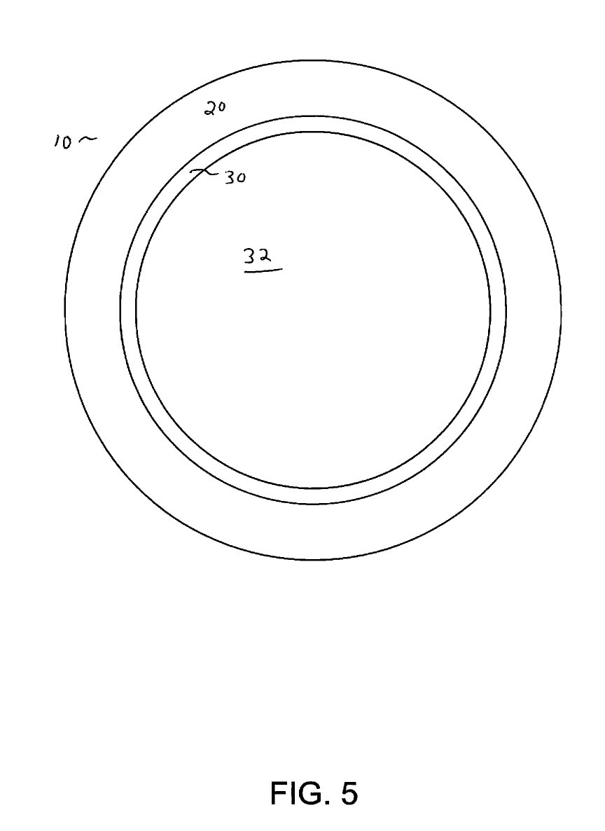

FIG. 6 is a perspective view thereof; and

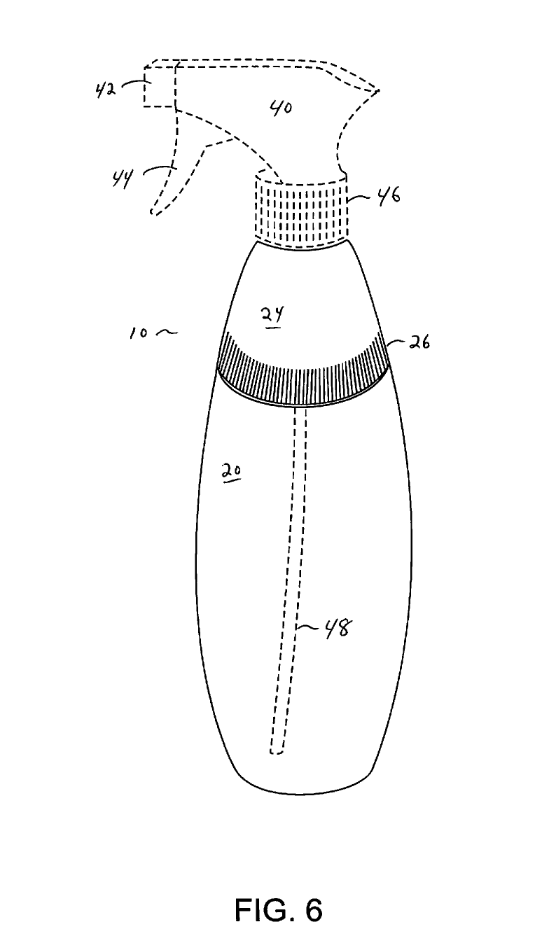

FIG. 7 is a perspective view of the spray container of U.S. Pat. No. 7,708,170, incorporated by reference, showing the recharging mechanism which in the embodiment shown is an impregnated strip.

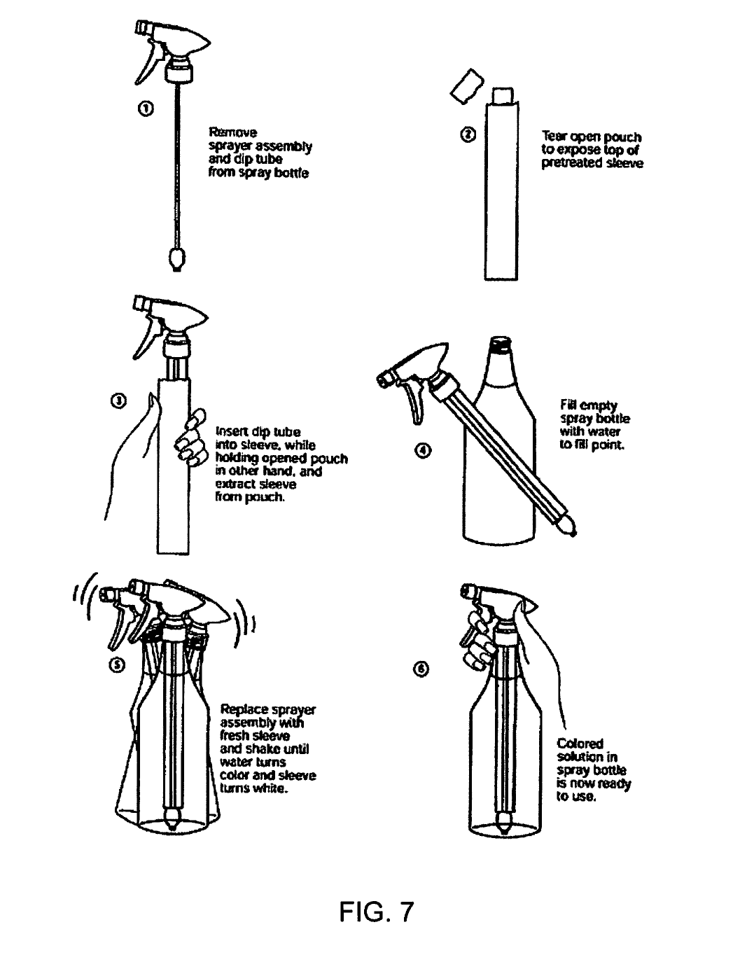

### DETAILED DESCRIPTION OF THE DRAWINGS

Referring now to the drawings, the rechargeable spray dispenser bottle 10 comprises a bottle 20 having an opening of 1.5 to 3 inches provided with screw threads 22 for attachment of an adaptor cap 24 which incorporates female screw threads for attachment to the bottle 20 and screw threads 26 for attaching a pump sprayer device 40 having a trigger handle 44 and a spray opening 42. The pump sprayer device is connected to a dip tube 48 which on activating the handle 44 causes spray solution to be delivered from the bottle 20 up through the dip tube 48 and out through the opening 42. The bottle's bottommost part is provided with a concave edge 30 and a dome shaped bottom 32.

### DETAILED DESCRIPTION OF THE PREFERRED EMBODIMENTS

The subject improved spray bottle system may be made and used in accordance with the apparatus and methods described in detail below.

Those skilled in the art will recognize that any type of clear, translucent, transparent, semi-transparent, or opaque material may be used to make the bottle container, thermoplastic resins being preferred.

Preferably, the container is made of thermoplastic polymer, for example, polycarbonate, polyethylene terephthalate, polybutylene terephthalate, polyurethane and similar moldable plastics. The containers may be blow molded to suitable size and shape.

In other embodiments, the spray bottle may comprise other materials to offer more variety and decorative options while maintaining the same function as with clear thermoplastic polymer material. In accordance with at least one embodiment, the spray containers may be made in different sizes and/or shapes.

An example of a rechargeable cleaning or sanitizing system which is particularly useful with the present spray bottle device is disclosed in U.S. Pat. No. 7,708,170 which is incorporated herein by reference.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be utilized without departing from the spirit and scope of the present invention as defined by the appended claims.

The invention now being fully described, it will be apparent to one of ordinary skill in the art that many changes and modifications can be made thereto without departing from the spirit or scope of the invention set forth herein.

1. A rechargeable spray bottle dispenser comprising a spray bottle portion having a resealable closure, said closure configured to be opened to allow liquid to flow therethrough and closed to seal said bottle portion, said rechargeable spray bottle dispenser comprising:
a) a bottle with an opening of 1.5 to 3 inches in diameter and incorporating female screw threads for attachment of an adaptor cap having a first opening corresponding to said bottle's wide opening, said adaptor cap having a second opening of about 1 inch in diameter for attachment to the bottle and for incorporating a pump sprayer device to allow liquid contents to flow therethrough;
b) said resealable closure being a screw-type sprayhead and a chemical refill insert adapted for containing a measured amount of concentrate agent, said insert being disposed within the bottle portion of said dispenser; and
c) said closure having screw threads for attaching a pump sprayer attachment, wherein on activation of said pump sprayer attached to said adaptor cap the solution containing concentrate is caused to be deliver from said bottle portion of said dispenser.

2. A rechargeable dispenser according to claim 1 wherein said pump sprayer device is suitable for repeated use.

3. A rechargeable dispenser according to claim 1 wherein said pump sprayer device is constructed of plastic.

4. A rechargeable dispenser according to claim I wherein said bottle has an opening of at least 2 inches in diameter.

5. A rechargeable dispenser according to claim 1 wherein said bottle is suited for accepting concentrate inserts for activating a wide variety of spray bottle solutions.

6. A rechargeable dispenser according to claim 5 wherein said concentrate insert includes a hard surface cleaner, sanitizer, disinfectant, plant cleaner, plant nutrient, pet care product, carpet cleaner, fabric fresheners or odor control product.

7. A rechargeable dispenser according to claim 6 wherein said concentrate is a liquid concentrate.

8. A rechargeable dispenser according to claim 1 wherein said bottle is made of polycarbonate.

9. A rechargeable dispenser according to claim 1 wherein said bottle is made of Tritan™.

10. A rechargeable dispenser according to claim 1 wherein said concentrate is a particulate product, the particles being of nanoparticle size.

11. A rechargeable dispenser according to claim 14 wherein said particles are incorporated into a woven strip.

12. A rechargeable dispenser according to claim 3 wherein said pump sprayer device is constructed of a thermoplastic polymer selected from the group consisting of polycarbonate, polyethylene terephthalate, polybutylene terephthalate and polyurethane.

13. A method of recharging a spray bottle dispenser according to claim 1 which comprises removing the spray head to open the spray bottle dispenser, introducing a measured amount of concentrate or refill into the empty bottle, refilling the bottle with water and reattaching the spray head to the bottle.

14. A method according to claim 13 wherein said concentrate is a liquid, pill, capsule or impregnated nonwoven fabric strip.

15. A rechargeable spray bottle dispenser according to claim 1 wherein said bottle is round in shape.
